(19) United States
(12) Patent Application Publication
(10) Pub. No.: US 2011/0038699 A1
(43) Pub. Date: Feb. 17, 2011

(54) Adjustable height trailer

(76) Inventor: Thanh Son Nguyen, Brisbane (AU)

Correspondence Address: DAVID AND RAYMOND PATENT FIRM, 108 N. YNEZ AVE., SUITE 128, MONTEREY PARK, CA, 91754, US

(21) Appl. No.: 12/804,890

(22) Filed: Jul. 30, 2010

(30) Foreign Application Priority Data
Aug. 14, 2009 (AU) 2009100804

(51) Int. Cl. B60P 1/02; B60P 1/04; B60P 1/16

(52) U.S. Cl. 414/495

(57) ABSTRACT

A trailer capable of being lowered to ground level for loading, unloading and tipping purposes includes a load carrying floor or tray and at least one pair of opposed ground engaging wheels connected to the trailer by means of dual purpose linkages which function not only as the main suspension components of the trailer but also to raise or lower the platform of the trailer without altering the camber of the wheels. The dual purpose linkages are actuated by inflatable fluid springs which provide the substantially horizontal force for raising and lowering the trailer. A safety mechanism is fitted to the trailer to prevent the trailer from hitting ground level in the event that an air spring fails. An adjustable level control is fitted to the trailer to regulate the air pressure in the air springs in order to maintain the platform of the trailer at a predetermined height.

### BACKGROUND OF THE PRESENT INVENTION

1. Field of Invention

This invention relates to trailers, in particular but not exclusively to a trailer to be towed by a vehicle which has a dual purpose suspension which allows the floor of the trailer to be lowered to the ground as well as functioning as the suspension of the trailer when the trailer is towed.

2. Description of Related Arts

Trailers for the carrying of goods which are towed behind vehicles are well known. In most cases, the trailers ride on at least a pair of ground engaging wheels which are connected beneath the trailer by an axle. In the case of prior art trailers, when the trailer is connected to a vehicle, the floor is substantially raised and the loading and unloading of goods onto or from the platform or floor of the trailer can be difficult. This is especially the case if the goods carried by the trailer are heavy or large which can result in injury. This has led to some manufacturers designing and supplying trailers which have a lowered floor or platform in relation to the wheel axle height. One such example is disclosed in U.S. Pat. No. 6,349,952 (Kallstrom) which describes a trailer having a centre load receiving channel for a motorcycle or similar load with a pair of oppositely extending wheel supporting axles that are pivotally mounted in the region of the central channel. The trailer also uses an air suspension system comprising vertically oriented bladder type air cylinders wherein controlling the inflation of the air cylinder allows the user to selectively deflate the air springs to lower the trailer into a position close to the ground so that the motorcycle can be loaded on the trailer. The air cylinders are then inflated to an operating or towing position.

The problems associated with this example of trailer is that as the trailer is loaded, the camber of the wheels move from a positive or neutral camber to that of a negative camber and therefore impinge into the potential payload area of the trailer as they circumscribe an arc. Furthermore, the elevating means disclosed in Kallstrom relies on a relationship between two pivotal arms 64 that provide the independent axles for each of the wheels provided on the trailer (see for example, FIG. 6 of Kallstrom), where one arm will not function without the other. Therefore, there is no way in which the elevating means of Kalstrom could be adapted to a trailer with only a single pair of wheels.

Furthermore, such swing axle arrangements are also dangerous when the trailer is being towed over a bumpy terrain wherein the trailer bounces off the ground and as it lands its wheels can land at an angle which could possibly disorient the trailer causing a jack-knifing situation.

Furthermore, as the trailer cannot be loaded further than the lowest axle clearance off the ground, a ramp is still required for the motorcycle to be loaded onto the trailer. This may result in an uneven or unbalanced platform when trying to unload or offload objects from the trailer when it is parked on a slope.

### SUMMARY OF THE PRESENT INVENTION

It is the object of the present invention to seek to ameliorate or overcome some of the disadvantages of the prior art and to provide a novel and innovative trailer wherein a load can be wheeled and rolled straight onto the floor or platform of the trailer at ground level.

In one aspect therefore the invention resides in a trailer capable of being lowered to ground level for loading, unloading and tipping purposes including in combination,

a load carrying floor or tray;

at least one pair of opposed ground engaging wheels;

dual purpose linkage means associated with each wheel actuated by a substantially horizontal force;

said linkage comprising the trailer suspension as well as adapted to raise and lower the trailer without altering the camber of the ground engaging wheels;

inflatable fluid spring means to provide the substantially horizontal force for raising and lowering the trailer as well as functioning as the suspension spring of the trailer when towed.

Preferably, the inflatable fluid spring means is a pneumatic or air spring which can be inflated or deflated to raise or lower the floor or tray of the trailer.

Preferably, the height of lowering or raising the trailer is controllable by the amount of air used to inflate the pneumatic spring.

Preferably, the trailer has a towing arm which is also adjustable to accommodate tow hitches of different heights.

Preferably, there can be a further fluid spring which is associated with the towing arm so that the floor or tray of the trailer can also be raised or lowered with respect to the towing hitch of a vehicle wherein the trailer can be used as a tipping trailer and/or to facilitate unloading of carried goods.

Suitably, there can be a safety mechanism fitted to the trailer to prevent the trailer from hitting ground level in the event that an air spring fails.

Preferably, there is also an adjustable level control fitted to the trailer to regulate the air pressure in the air springs to maintain the platform of the trailer at a predetermined height.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

In order for the invention to be better understood and put into practical effect reference will now be made to the following drawings, wherein,

FIG. 1 shows a plan view of a preferred trailer according to the invention;

FIG. 2 shows an elevation of the trailer of FIG. 1 in the lowered position;

FIG. 3 shows the trailer of FIG. 2 in the raised or towed position;

FIG. 4 shows a preferred safety mechanism which can be fitted to the trailer, and

FIG. 5 shows an automatic leveling mechanism which can be fitted to the trailer.

### DETAILED DESCRIPTION OF THE PREFERRED EMBODIMENT

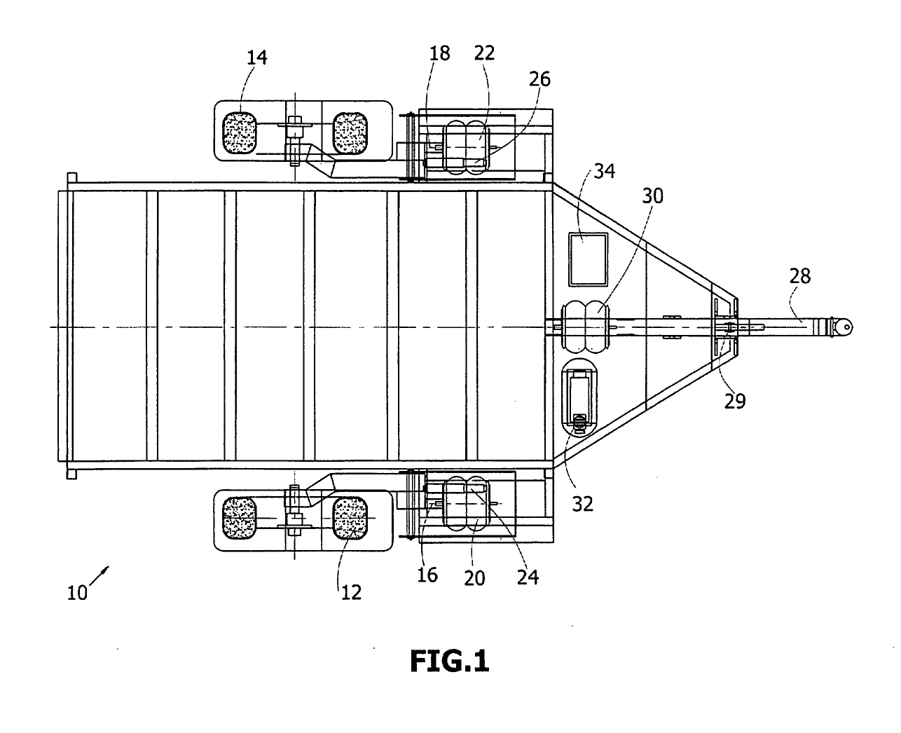

Referring now to FIG. 1 there is shown a plan view of the trailer 10 according to a preferred embodiment of the invention. In this example, the trailer has a pair of ground engaging wheels 12, 14 on either side of the trailer. The ground engaging wheels are connected to the trailer by means of dual purpose linkages 16, 18 which function not only to raise or lower the platform of the trailer but also as the main suspension components of the trailer.

Actuating the linkages is a pair of pneumatic air springs 20, 22. In this example, telescopic shock absorbers 24, 26 are also associated with the linkages as part of the suspension.

The trailer has a height adjustable towing arm 28 which can have a manual ratchet system 29 to lock the towing arm at a certain height and is also operated by means of an air spring 30.

In this example, the air springs 20, 22, 30 are inflated by an electrical pump 32 which can have a remote battery 34 or can be connected to the battery of the vehicle.

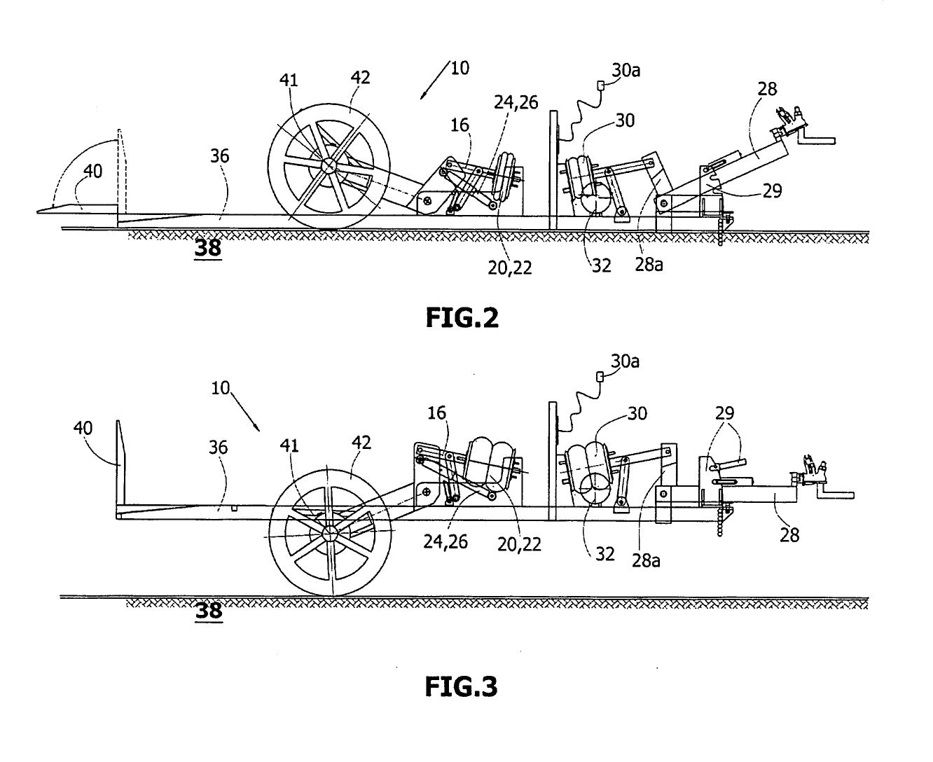

Referring now to FIG. 2 there is shown the trailer 10 of FIG. 1 wherein the platform or floor 36 is at ground level 38.

There can be a ramp 40 attached to the trailer which can function as a tailgate.

In this view, the air springs 20, 22 of the trailer are deflated wherein the linkages 16, 18 are allowed to pivot such that the floor of the trailer can be lowered.

The trailer in this example has an electrically powered air compressor 32 used to inflate or deflate the bellows of the air springs.

Also shown at the front of the trailer is a height adjustable towing arm 28 which can have a manual ratchet system 29 to lock the towing arm at a certain height and is also operated by means of an air spring 30. This allows the front of the trailer to be raised or lowered with respect to the rear of the trailer wherein the floor or platform of the trailer can be sloped to facilitate the unloading of goods. This can also provide the trailer with a tipping function where gravel or other loose goods are carried and can be tipped out of the trailer as the towing arm is operated by means of the air spring 30.

FIG. 3 shows the trailer 10 in the tow or operational position wherein the floor 36 or platform of the trailer is raised to its operating height by inflating the air springs 20, 22 of the suspension system. In this case the linkages 16, 18 are pushed by the horizontal actuating force of the inflatable air springs such that a lever action of the linkage raises the floor or platform with respect to the axis 41 of the wheel 42.

In this case, also the air spring 30 of the towing arm 28 is fully inflated by means of remote control 30a such that the towing arm is lowered by a lever arrangement 28a against the platform 36 at the towing height and the manual ratchet locking system 29 locks the towing arm in place. The tailgate 40 is also in the upright position thereby securing the load. In this view, the shock absorbers 24, 26 are is also fully extended to function as part of the suspension. It would be envisaged that the invention would be beneficial for small businesses that require the delivery of heavy goods such as white goods and appliances. The trailer can also be part of a trailer hire system for short-term consumer use.

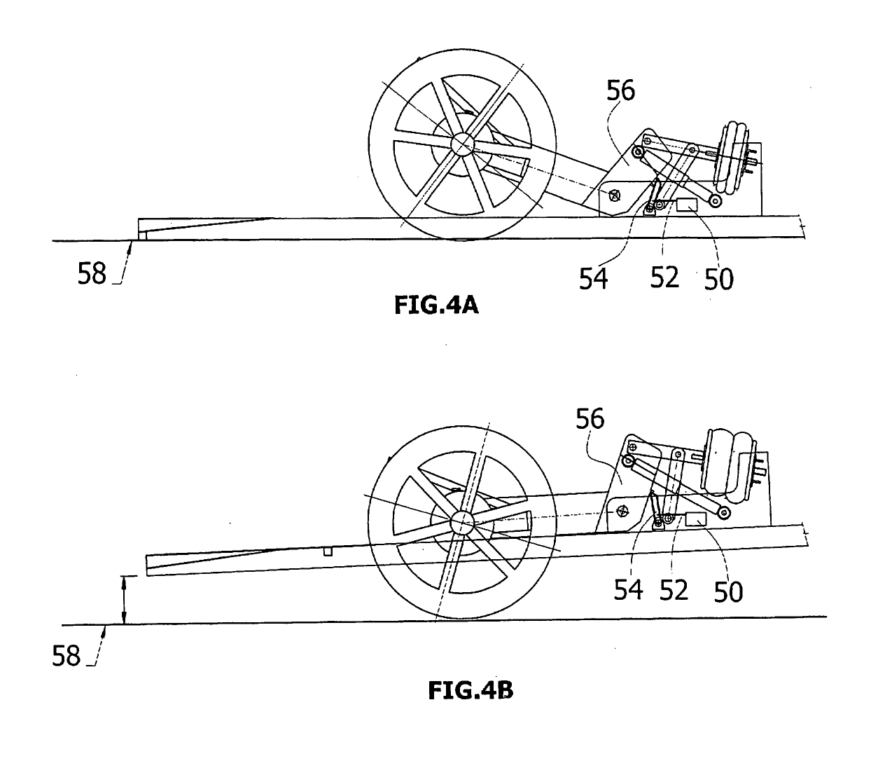

FIGS. 4A and 4B show a preferred safety mechanism which can be fitted to the trailer. This handbrake-type lever mechanism 50 is situated at the front of the trailer and controls the release and locking of the front end vertical movement of the trailer. A cable 52 is connected to the lever 50 which connects to the sides of the trailer. This connection controls a “stopper” 54 that suspends the arms 56 of the wheel in place, which essentially stops the platform from hitting ground level 58. This feature is useful as a safety measure should the air spring break and fall suddenly, which would prevent the crushing of feet, for example.

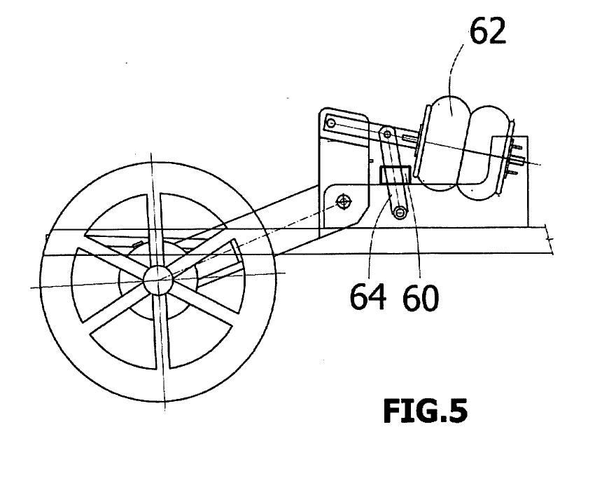

FIG. 5 shows an adjustable leveling mechanism 60 which can be fitted to the trailer. This electric device automatically controls the intake and outtake of air pressure in the air springs 62 via a sensor (not shown) controlled by the position of a linkage system 64. For example, when Automatic Level Control (ALC) is switched on, the system will adjust the air pressure in the air springs to maintain a predetermined height of the trailer. When the load is increased, more air will be pumped into the air springs to increase the height of the trailer. Conversely, when the load has lightened, air will be released from the air springs to decrease the height.

### Variations

It will of course be realized that while the foregoing has been given by way of illustrative example of this invention, all such and other modifications and variations thereto as would be apparent to persons skilled in the art are deemed to fall within the broad scope and ambit of this invention as is herein set forth.

In the specification the terms “comprising” and “containing” shall be understood to have a broad meaning similar to the term “including” and will be understood to imply the inclusion of a stated integer or step or group of integers or steps but not the exclusion of any other integer or step or group of integers or steps. This definition also applies to variations on the terms “comprising” and “containing” such as “comprise”, “comprises”, “contain” and “contains”.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A trailer capable of being lowered to ground level for loading, unloading and tipping purposes, comprising:
a load carrying floor or tray;
at least one pair of opposed ground engaging wheels;
a towing arm which is height adjustable to accommodate vehicle tow hitches of different heights;
dual purpose linkage means associated with each wheel actuated by a substantially horizontal force;
said linkage comprising the trailer suspension as well as adapted to raise and lower the trailer without altering the camber of the ground engaging wheels; and
inflatable fluid spring means to provide the substantially horizontal force for raising and lowering the trailer as well as functioning as the suspension spring of the trailer when towed.

2. A trailer as claimed in claim 1 wherein the inflatable fluid spring means is an air or pneumatic spring which can be inflated or deflated to raise or lower the floor or tray of the trailer that is controllable by the amount of air used to inflate the pneumatic spring.

3-5. (canceled)

6. The trailer, as recited in claim 1, further comprising a safety mechanism that prevents the trailer from hitting ground level in the event that an air spring fails.

7. The trailer, as recited in claim 2, further comprising a safety mechanism that prevents the trailer from hitting ground level in the event that an air spring fails.

8. The trailer, as recited in claim 1, further comprising an adjustable level control fitted to the trailer to regulate the air pressure in the air springs to maintain the platform of the trailer at a predetermined height.

9. The trailer, as recited in claim 2, further comprising an adjustable level control fitted to the trailer to regulate the air pressure in the air springs to maintain the platform of the trailer at a predetermined height.

10. The trailer, as recited in claim 6, further comprising an adjustable level control fitted to the trailer to regulate the air pressure in the air springs to maintain the platform of the trailer at a predetermined height.

11. The trailer, as recited in claim 7, further comprising an adjustable level control fitted to the trailer to regulate the air pressure in the air springs to maintain the platform of the trailer at a predetermined height.

12. The trailer, as recited in claim 1, wherein the trailer has a single pair of opposed ground engaging wheels.

13. The trailer, as recited in claim 2, wherein the trailer has a single pair of opposed ground engaging wheels.

14. The trailer, as recited in claim 6, wherein the trailer has a single pair of opposed ground engaging wheels.

15. The trailer, as recited in claim 7, wherein the trailer has a single pair of opposed ground engaging wheels.

16. The trailer, as recited in claim 8, wherein the trailer has a single pair of opposed ground engaging wheels.

17. The trailer, as recited in claim 9, wherein the trailer has a single pair of opposed ground engaging wheels.

18. The trailer, as recited in claim 10, wherein the trailer has a single pair of opposed ground engaging wheels.

19. The trailer, as recited in claim 11, wherein the trailer has a single pair of opposed ground engaging wheels.
